(19) United States
(12) Patent Application Publication
(10) Pub. No.: US 2007/0139528 A1
(43) Pub. Date: Jun. 21, 2007

(54) Vibration reduction apparatus

(75) Inventor: Wei-Chung Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/481,650

(22) Filed: Jul. 5, 2006

(30) Foreign Application Priority Data
Dec. 16, 2005 (CN) 200510120693.9

(51) Int. Cl. H04N 5/228

(52) U.S. Cl. 348/208.11

(57) ABSTRACT

A vibration reduction apparatus (30) for a camera module includes a compensative lens element (32), an elastic element (38), a clamping element (34) and a driving element (36). The compensative lens element is positioned in the elastic element. The clamping element receives the compensative lens element and the elastic element. The driving element is configured for controlling the movement of the compensative lens element in response to vibration.

### TECHNICAL FIELD

The present invention relates generally to vibration reduction apparatus, and more particularly, to a vibration reduction apparatus mounted in a digital camera.

### BACKGROUND

In some cameras, when a photographer moves even slightly whilst capturing an image, the object image moves relative to the camera and the taken picture becomes a so-called vibrated picture with unclear edges. In order to solve this problem, in recent years, cameras capable of reducing vibration of the camera relative to the object image by moving a vibration reduction apparatus in a manner so as to cancel out the movement of the photographer have been developed.

However, this kind of vibration reduction apparatus only may displace lens elements, and cannot tilt lens elements and the adjustment is therefore limited.

Therefore, a new vibration reduction apparatus is desired in order to overcome the above-described shortcomings.

### SUMMARY

One embodiment of a vibration reduction apparatus for a camera module includes a compensative lens element, an elastic element, a clamping element and a driving element. The compensative lens element is positioned in the elastic element. The clamping element receives the compensative lens element and the elastic element. The driving element is configured for controlling the movement of the compensative lens element in response to vibration subject to the camera module.

Other advantages and novel features will become more apparent from the following detailed description when taken in conjunction with the accompanying drawings.

### BRIEF DESCRIPTION OF THE DRAWINGS

Many aspects of the present vibration reduction apparatus can be better understood with reference to the following drawings. The components in the drawings are not necessarily drawn to scale, the emphasis instead being placed upon clearly illustrating the principles of the vibration reduction apparatus. Moreover, in the drawings, like reference numerals designate corresponding parts throughout the several views.

FIG. 1 is an exposed, isometric view of a vibration reduction apparatus;

FIG. 2 is an assembled view of the vibration reduction apparatus;

FIG. 3 is a rotated cross-sectional view of FIG. 2 along lines III-III; and

FIG. 4 is a view of the vibration reduction apparatus in action.

### DETAILED DESCRIPTION OF THE PERFERRED EMBODIMENTS

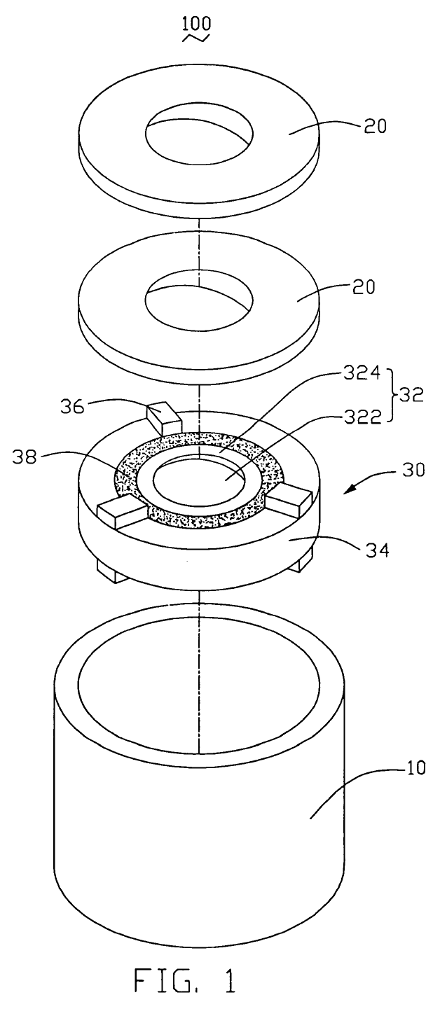

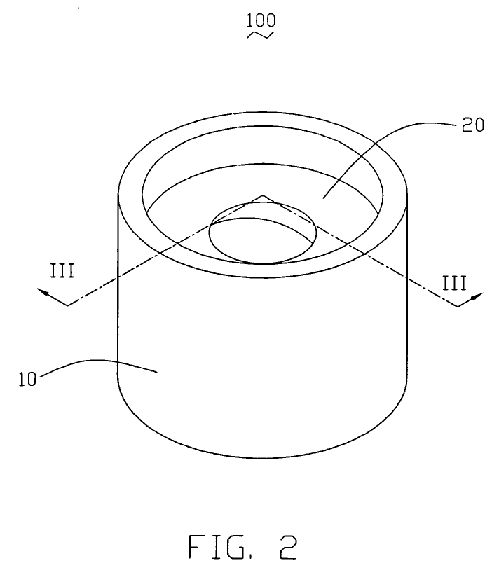

Referring to FIGS. 1 and 2, a digital camera lens module 100 includes a barrel 10, several lens elements 20 and a vibration reduction apparatus 30 in accordance with a preferred embodiment. The vibration reduction apparatus 30 includes a compensative lens element 32, a clamping element 34, nine electromagnets 36 and an elastic element 38.

The barrel 10 is substantially a hollow cylinder with two open ends so that light can be transmitted therethrough. The lens elements 20 may be secured in the barrel 10, and receive incoming light that enters from the outside.

The vibration reduction apparatus 30 may be positioned in the barrel 10. The compensative lens element 32 includes an image portion 322 and a mounting portion 324 formed together. The mounting portion 324 surrounds a periphery of the image portion 322. The surfaces of the mounting portion 322 are coated with iron or magnetic material or the like.

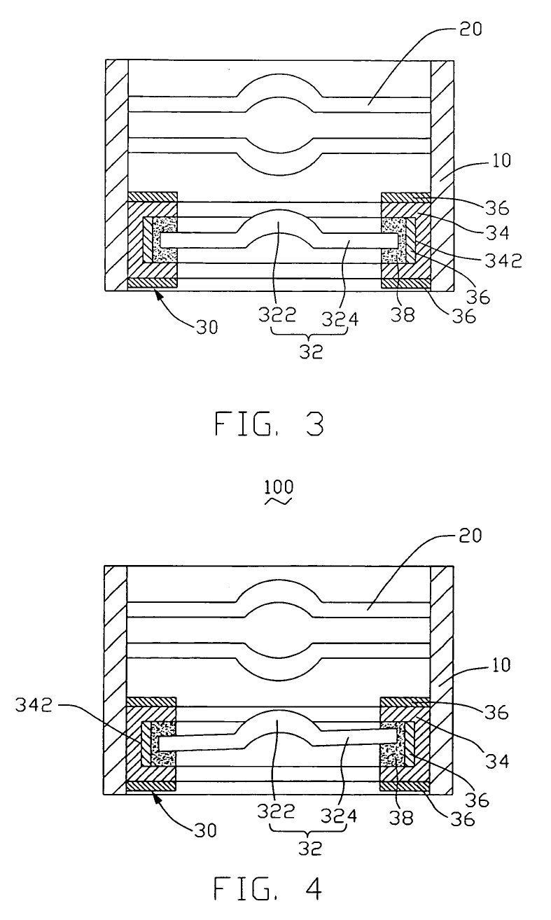

Referring to FIG. 3, the clamping element 34 is substantially a ring cylinder. An inner peripheral wall of the clamping element 34 defines a receiving groove 342. The receiving groove 342 is substantially a cylindrical cavity.

Each electromagnet 36 is substantially rectangular. The nine electromagnets 36 are divided into three groups. Three electromagnets 36 of a first group are positioned on a top surface of the clamping element 34. Opposite to the electromagnets 36 on the top surface, another three electromagnets 36 of a second group are positioned on a bottom surface of the clamping element 34. The last three electromagnets 36 of a third group are received in the receiving groove 342 between the top surface and the bottom surface, and are pressed on a bottom wall of the receiving groove 342. Three electromagnets 36 of each group are separated by 120 degrees from each other. The electromagnets 36 are attached to the clamping element 34 by means of an adhesive. Each electromagnet 36 further connects to an electrode (not shown), thereby each electrode can independently control a corresponding electromagnet 36. The electromagnets 36 may produce magnetic forces when the electrodes are electrified. The magnetic forces will attract the mounting portion 324 of the compensative lens element 32 so as to cause the compensative lens element 32 to move. As the nine electromagnets 36 are set in different positions, the position of the compensative lens element 32 may be adjusted from many angles in response to vibration of the digital camera module.

The elastic element 38 can be made of elastic material such as plastics, sponge or the like. The elastic element 38 may be received in the receiving groove 342 of the clamping element 34, and the compensative lens element 32 may be further positioned in the elastic element 38. The elastic element 38 may not only support the compensative lens element 32, but also allow the compensative lens element 38 tilt or flex under the magnetic forces of the magnets 36.

In assembly, firstly three of the electromagnets 36 are positioned in the receiving groove 342 of the clamping element 34, and are respectively adhered to the bottom wall of the receiving groove 342. The elastic element 38 is then received in the receiving groove 342 so as to press the magnets 36 toward the bottom wall. Then, the mounting portion 324 is inserted into the elastic element 38. The elastic element 38 is deformable, and can lock the compensative lens element 32 in the elastic element 38. Another three of the electromagnets 36 are adhered to the top surface of the clamping element 34, and the last three of the electromagnets 36 are adhered to the bottom surface of the clamping element 34. After that, the assembled clamping element 34 is positioned in the barrel 10, and is mounted in the barrel 10. Finally, the lens elements 20 are fixed in the barrel 10. An optical axis of the image portion 322 is aligned with that of the lens elements 20. The assembly process of the digital camera lens module 100 is thus completed.

Referring to FIG. 4, when the digital camera lens module 100 vibrates, a lens position detector of a digital camera may detect the extent of the vibration. The detector transmits vibration data to a control apparatus. The control apparatus of the digital camera receives the data from the detector and provides different voltage to each electrode. The electrode further controls a corresponding electromagnet 36 to produce different magnetic forces. Accordingly, the position of the compensative lens element 32 may be adjusted under the interactions of magnetic forces so that the compensative lens element 32 may compensate the effects of the vibration so as to eliminate aberration.

In an alternative embodiment, the arrangement of the electromagnets 36 may be changed so long as the electromagnets 36 are spaced from each other. The clamping element 34 can be of another shape such as cylinder-shaped, or column-shaped with a pentagonal or hexagonal cross-section.

In the above-mentioned embodiments, the electromagnets act as a driving element for tilting the compensative lens elements. Understandably, the driving element disclosed above may be replaced with other structures such as motors.

It is believed that the present embodiments and their advantages will be understood from the foregoing description, and it will be apparent that various changes may be made thereto without departing from the spirit and scope of the invention or sacrificing all of its material advantages, the examples herein described merely being preferred or exemplary embodiments of the invention.

What is claimed is:

1. A vibration reduction apparatus for a camera module, comprising:
a compensative lens element;
an elastic element, the compensative lens element positioned in the elastic element;
a clamping element receiving the compensative lens element and the elastic element; and
a driving element configured for controlling the movement of the compensative lens element in response to vibration subject to the camera module.

2. The vibration reduction apparatus as claimed in claim 1, wherein the compensative lens element includes an image portion and a mounting portion, and the mounting portion is coated with one of iron and magnetic material.

3. The vibration reduction apparatus as claimed in claim 2, wherein the driving element is made up of a plurality of electromagnets, and the electromagnets bring the mounting portion of the compensative lens element to move in the elastic element.

4. The vibration reduction apparatus as claimed in claim 1, wherein the clamping element is a ring cylinder, the clamping element defines a receiving groove, and the elastic element with the compensative lens element is received in the receiving groove.

5. The vibration reduction apparatus as claimed in claim 4, wherein the driving element includes nine electromagnets, the nine electromagnets are equally divided into three groups, three electromagnets of a first group are positioned on one end surface thereof, another three electromagnets of a second group are positioned on the other end surface thereof, and the last three electromagnets of a third group are positioned in the receiving groove.

6. The vibration reduction apparatus as claimed in claim 6, wherein three electromagnets of each group are separated by 120 degrees.

7. The vibration reduction apparatus as claimed in claim 1, wherein the elastic element is made of plastic material or sponge.

8. A digital camera lens module comprising:
at least one camera lens element;
a compensative lens element positioned spacing from the at least one camera lens element;
an elastic element, the compensative lens element positioned in the elastic element;
a clamping element receiving the compensative lens element and the elastic element; and
a driving element moving the compensative lens element with respect to the at least one camera lens element when the camera lens module is subjected to vibration in a manner so as to eliminate aberration.

9. The digital camera lens module as claimed in claim 8, further comprising a barrel, wherein the barrel receives the at least one camera lens element, the compensative lens element, the elastic element, the clamping element and the driving element.

10. The digital camera lens module as claimed in claim 8, wherein the compensative lens element includes an image portion and a mounting portion, and the mounting portion is coated with iron or magnetic material.

11. The digital camera lens module as claimed in claim 10, wherein the driving element is made up of a plurality of electromagnets, and the electromagnets bring the mounting portion of the compensative lens element to move in the elastic element.

12. The digital camera lens module as claimed in claim 8, wherein the clamping element is a ring cylinder, the clamping element defines a receiving groove, and the elastic element is received in the receiving groove.

13. The digital camera lens module as claimed in claim 12, wherein the driving element includes nine electromagnets, the nine electromagnets are equally divided into three groups, three electromagnets of a first group are positioned on one end surface thereof, another three electromagnets of a second group are positioned on the other end surface thereof, and the last three electromagnets of a third group are positioned in the receiving groove.

14. The digital camera lens module as claimed in claim 13, wherein three electromagnets of each group are separated by 120 degrees.

15. A vibration reduction apparatus comprising:
an optical lens element;
a deformable element, the deformable element movably supporting the optical lens element; and
at least one electromagnet positioned in the deformable element and attracting the optical lens element so as to adjust position of the optical lens element.

16. The vibration reduction apparatus as claimed in claim 15, wherein the optical lens element includes an image portion and a mounting portion, and the mounting portion is coated with iron or magnetic material.

17. The vibration reduction apparatus as claimed in claim 16, wherein the number of electromagnets is nine, and the electromagnets bring the mounting portion of the optical lens element to move in the elastic element.

18. The vibration reduction apparatus as claimed in claim 15, further comprising a clamping element, wherein the clamping element is a ring cylinder, the clamping element defines a receiving groove, and the deformable element is received in the receiving groove.

19. The vibration reduction apparatus as claimed in claim 18, wherein the clamping element encloses an outer periphery of the optical lens element.

20. The vibration reduction apparatus as claimed in claim 18, wherein the nine electromagnets are equally divided into three groups, three electromagnets of a first group are positioned on one end surface of the clamping element, another three electromagnets of a second group are positioned on the other end surface of the clamping element and the last three electromagnets of a third group are positioned in the receiving groove of the clamping element.
